(19) United States
(12) Patent Application Publication
(10) Pub. No.: US 2015/0040886 A1
(43) Pub. Date: Feb. 12, 2015

(54) Safe Charcoal Starter with Contoured Hinged Grate

(71) Applicants: Kathy Elizabeth Phelps, Lilburn, GA (US); Stephen Lawrence Phelps, Lilburn, GA (US)

(72) Inventors: Kathy Elizabeth Phelps, Lilburn, GA (US); Stephen Lawrence Phelps, Lilburn, GA (US)

(21) Appl. No.: 13/962,748

(22) Filed: Aug. 8, 2013

(51) Int. Cl. A47J 37/07

(52) U.S. Cl. CPC A47J 37/079
USPC 126/25 B

(57) ABSTRACT

The improved charcoal starter design has a contoured, perforated, contoured single piece hinged grate that, when the release mechanism is activated, will allow it to rotate downward about the axis of its hinge and create an unobstructed exit path for the incandescent coals to be safely deposit hot embers into the grill.

### BACKGROUND OF THE INVENTION

1. Field of Invention

This invention generally relates to charcoal starters having a housing which provides an upper chamber to contain the charcoal, a lower chamber to provide a space for a charcoal igniter such as wadded up newspaper, and a grate to separate the upper and lower chambers and to hold the charcoal in position. They also typically provide a plurality of ventilation holes that allow air to pass through the housing and up through the perforated grate plus a handle for dispensing and portability. This type of charcoal starter is preferred over the charcoal lighter fluid method, which is a slow process and can leave a petroleum taste in the food cooked later.

2. Description of Prior Art

Charcoal starters or chimneys are well known and readily available in a variety of shapes and sizes, all having the same intent to deliver incandescent coals for heating or cooking. The typical charcoal starter consists of housing with vertical walls that has an opening at the top and the bottom. Located inside of the housing is a perforated grate that creates an upper chamber and a lower chamber. The upper chamber is used to store the charcoal that is to be heated. The lower chamber is used to store some type of burnable material, such as wadded up paper. The paper is ignited and burns long enough to ignite the charcoal that is at the bottom of the upper chamber. Then over a period of time, the charcoal at the bottom of the upper chamber heats and ignites the rest of the charcoal in the upper chamber. A handle is attached to the outside of the housing to allow the user to manipulate the charcoal chimney to move it from one location to another and to turn it over to deposit the hot coals into the grill. Some charcoal chimneys include a heat shield located between the handle and the housing to protect the users hand from the heat generated by the burning coals. The majority of devices require the dangerous method of pouring incandescent coals into a barbeque grill with no protection from the incandescent embers and ash that are splashed about in the bottom of the grill and possibly injuring the user of the device.

One such device is described in U.S. Pat. No. 5,230,325 to Stanley J. Williams. This excellent invention describes a method to protect the user from the dangerously hot sidewalls of the charcoal starter. Although this invention does provide a certain level of safety to the user, it does not protect the user from the splashing of incandescent embers and ash because it requires the user to pour them into the grill.

In another excellent invention as described in U.S. Pat. No. 5,638,807 to Judith Flamenbaum, a method to prevent the splashing of incandescent coals and ash is described by having a 2 piece fold down or drop down grate. Although this creates a path for the incandescent coals and ash to drop out of the bottom of the device and eliminate the need for the pouring of the incandescent coals and ash, this method requires a 2 piece fold down grate plus, its support members which are placed in the path of the incandescent coals and creates an obstructed exit path for the coals. The obstruction in the charcoal exit path means the incandescent coals can become lodged or stuck inside of the charcoal chimney. This would cause the user to shake the charcoal chimney too loosen them from their stuck position or turn the charcoal chimney over to deposit the incandescent coals and ash into the barbeque grill. Either scenario puts the user in the same danger it was trying to avoid. Although this invention could provide for a certain level of safety for the user from splashing incandescent coals and ash, if no coals become lodged, it is also significantly more complex to produce than the present invention by adding substantially more cost to the charcoal chimney due the number of components required to activate the release mechanism and to allow the two-piece grate to fold down. The improvements described in the present invention not only allow for an unobstructed exit path for the charcoals, but does so with the least amount of parts needed, but does it in a more safe and cost effective manner.

In another excellent invention as described in U.S. Pat. No. 4,282,854 to Garner B. Byars describes a method for heating charcoal to incandescent and using a hinged grate to drop the incandescent charcoals out the bottom of the charcoal starter and into the grill. The Byars patent employs the use of a single piece hinged grate. The grate automatically opens by gravity when the charcoal starter is lifted. This limits the dispensing of the incandescent coals to the exact location the charcoal starter is set down when the wadded up paper is ignited. In addition, because the grate is round and flat, by design, the flat hinged grate cannot drop open completely vertical, because of this, it creates an obstructed exit path which can cause the incandescent coals to become lodged or stuck within the housing. The flat grate will rotate downward until it hits the inside of the housing. The point at which the flat grate hits the inside of the housing is when the outside diameter of the grate equals the distance across the inside diameter of the housing. The improved charcoal starter described in this patent, because the release mechanism locks the hinged grate in place until activated, allows the charcoal starter to be moved from one location to another location for the dispensing of the incandescent coals. In addition, the contoured grate allows the grate to drop open completely vertical creating an unobstructed exit past for the incandescent coals.

In another excellent invention as described in U.S. Pat. Nos. 4,321,907 and 4,461,270 to Richard A. Sutter in which a hinged grate is described and uses a trigger mechanism to release the hot embers safely into the grill. Although innovative by use of the trigger mechanism, the release of the trigger requires the use of two hands, one hand to hold the charcoal starter and the other hand to release trigger, thus allowing the hinged grate to rotate about the hinge and deposit the hot embers into the grill. However using the second hand to release the trigger mechanism puts the second hand dangerously close to the hot charcoal starter housing. Also, the heat from the hot embers will be transferred down the metal wire frame and cause the trigger to become hot to the touch. In addition, because the grate is round and flat, it will create an obstructed exit path for the incandescent coals. The charcoal starter described in this patent not only allows for a one handed operation with a thermally insulated release handle, used to activate the release mechanism, but also creates an unobstructed exit path for the incandescent coals, thus making the operation easy and safe to use.

Yet another excellent invention as described in Pat. No. 5,469,835 to James C. Stephen, Erich J. Schlosser and Ewald Seig in which a bale type or second handle is described to aid in the handling of the charcoal starter while transporting the coals to another location to another and for depositing the hot coals into the grill. The invention describes the second handle as being attached to either the housing itself or the heat shield. Attaching the second handle to the housing puts the handle in direct contact with the side wall of the housing that is in direct contact with the hot embers and thus transferring the heat to the handle making it hot to touch. It also allows for the second handle to be attached to the heat shield of the charcoal starter. The problem with this design is that it requires the heat shield to be made of heavy gauge material in order to handle the weight of the charcoal starter with a full load of charcoal. This adds unnecessary cost to the charcoal starter. The second handle as described in this patent is pivotally attached to the main handle of the charcoal starter. This not only removes the second handle from direct contact with the hot sidewalls of the housing, but it also attaches it to the main handle which already designed to hold the weight of the charcoal starter loaded with coals.

### SUMMARY OF INVENTION

The present invention provides a means by which all of the above problems are satisfied. This improved charcoal starter provides a housing with vertical sidewalls making a complete enclosure with an open top and an open bottom, a contoured single piece hinged grate that separates the inside of the housing into an upper chamber, to hold the charcoal, and a lower chamber, for combustibles, like wadded up paper, a thermally insulated handle for safety and portability, and a release mechanism attached to the handle, that when activated, releases one side of the contoured single piece grate allowing it to rotate about the hinge which then creates an opening for the incandescent coals and ash to drop safely out the bottom of the device and into the barbeque grill.

An object of the improved charcoal starter is a simple hinged contoured single piece grate where the grate is contoured to compliment the inside of the housing, the release mechanism, when activated by pulling the release handle, permits the grate to rotate downward about the hinge to an open position and thus allows the incandescent coals and ash to drop safely into the barbeque grill. Although there are many ways to create a grate that compliments the housing, the preferred method as shown in the drawings, show a substantially circular grate that is flat in the middle for a distance and then is turned upward at an angle that compliments the diameter of the housing. Although one skilled in the art could create a plethora of grate profiles whose contour compliments the shape of the housing, two common designs might be a rounded profile or a “V” shaped profile.

The invention also provides for an upper chamber and lower chamber separated by the contoured single piece hinged grate. The upper chamber is provided to hold the charcoal or like material while heat is being applied until the charcoals become incandescent and ready for use. The lower chamber is provided as a location to provide a heat source to the charcoals. A typical material used as a heat source would be wadded up paper.

The invention also provides a handle for portability. Although the drawings show primarily a vertical handle attached to the sidewalls, one skilled in the art could provide several other options for making the charcoal starter portable. The method described in this patent was used to provide a one handed operation of lifting the charcoal starter to the desired location and activating the release mechanism, thus, opening the grate for depositing the incandescent coals safely into the grill.

The invention also provides for a second handle that is pivotally attached to the main handle which provides for additional stability. The second handle is attached to the main handle because it provides for the most support as compared to attaching it to the heat shield and provides a greater distance from the heat as compared to attaching it to the housing itself.

The invention also provides a release mechanism for the contoured single piece hinged grate. As shown in the drawings, the release mechanism consists of a horizontal release member where one end protrudes into the housing and prevents the contoured single piece hinged grate from rotating to the open position and a vertical release member that is fixedly attached to the horizontal release member. The release mechanism can be moved forward to allow the horizontal release member to block the contoured single piece hinged grate from rotating to the open position or moved backward to allow the contoured single piece hinged grate to rotate downward to the open position to provide an unobstructed exit path for the incandescent coals. The system can be reset by rotating the charcoal starter upside-down, then pulling the vertical release member backward and allow gravity to rotate the contoured single piece hinged grate to rotate back into a closed position. The vertical release member is then moved forward which moves the horizontal release member into a position that blocks the contoured single piece hinged grate and prevents it from rotating.

It should be noted that the operation of the release mechanism is operated manually, but could be assisted by the spring. A spring could be added to either the horizontal release member or the vertical release member to hold the release mechanism in a closed position that is biased to always blocks the contoured single piece hinged grate and prevents it from rotating.

It should additionally be noted that the resetting of the contoured single piece hinged grate could be aided by the addition of a spring to the hinge, with a spring force is greater then the weight of the grate itself so, it would rotate back into position when the charcoal starter is empty thus eliminating the need to flip the charcoal starter upside down. However, the spring force would need to be less than the weight of the grate plus a minimal amount of charcoal, so that all of the incandescent embers would be safely deposited into the grill.

An additional benefit to the present invention is the addition of a locking feature for the release mechanism itself. To prevent the accidental activation of the release mechanism, a locking feature can be added to prevent the user from accidentally moving the release mechanism from the closed position to the open position and thus prematurely releasing the coals. The preferred method is the implementation of a cutout in the lower main handle support that has two positions. Position one is the locked closed position and position two is the unlocked open position. Position one being a slot in the cutout that holds the release mechanism in the closed position that prevents it from moving toward the main handle and into the open position. This holds the horizontal release member under the single piece hinged grate preventing it from rotating. When the release mechanism is locked in place, the charcoal chimney can to be moved from one location to another without an accidental deployment of the charcoal. Position two would allow the release mechanism to move toward the main handle and into the open position such that the release mechanism will be moved out from under the contoured single piece hinged grate allowing it to rotate downward into the open position and depositing the coals into the grill. There would be a small channel that connects both positions allowing the user to move the release mechanism from one location to the other when needed. Although this is the preferred locking mechanism, one skilled in the art could provide several different methods to hold the release mechanism in the closed position, one being a locking tab. The locking tab would be attached to the main handle support by a pin, screw or other means that would allow the locking tab to rotate from position one to position two. Position one would align the locking tab with the release mechanism and prevent it from moving out the closed position and into the open position. When the locking tab is rotated out of alignment with the release mechanism, the release mechanism would then be able to move from the closed position to the open position and thus deposit the coals into the grill.

### BRIEF LIST OF REFERENCE NUMERALS UTILIZED IN THE DRAWINGS

1—Charcoal starter
2—Contoured Single Piece Hinged Grate
3—Hinge Tab
4—Pivot Hole
5—Release Mechanism
6—Horizontal Release Member
7—Vertical Release Member
8—Insulated Handle
9—Bend Line
10—Contour Section
11—Heat Shield
12—Main Handle
13—Lower Chamber
14—Upper Chamber
15—Charcoal Starter Housing
16—Charcoal Starter Housing Opening
17—Upper Main Handle Support Slot
18—Lower Main Handle Support Slot
19—Grate Ventilation Holes
20—Grate Support Protrusion
21—Second Handle
22—Flat Grate
23—Assembly Rivet
24—Main Handle Support
25—Impact Point
26—Second Handle Support
27—Return Spring
28—Return Spring Support
29—Cutout Locking Feature
30—Locked Position
31—Unlocked Position
32—Locking Tab
33—Locking Tab Hinge Pin

### BRIEF DESCRIPTION OF THE DRAWINGS

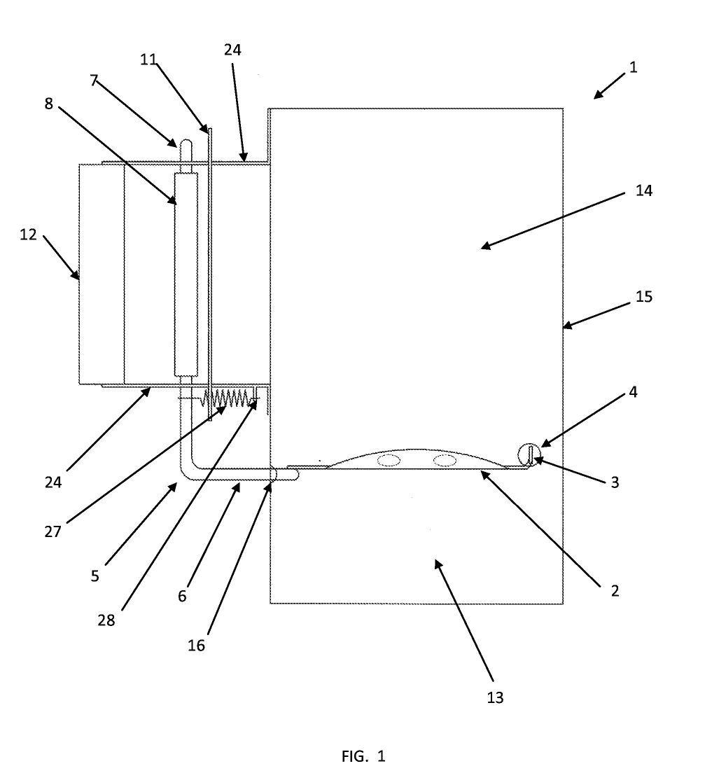

FIG. 1 is a side view of the invention with a section of the charcoal housing removed to better show the contoured single piece hinged grate in the closed position with the release mechanism also shown in the closed position.

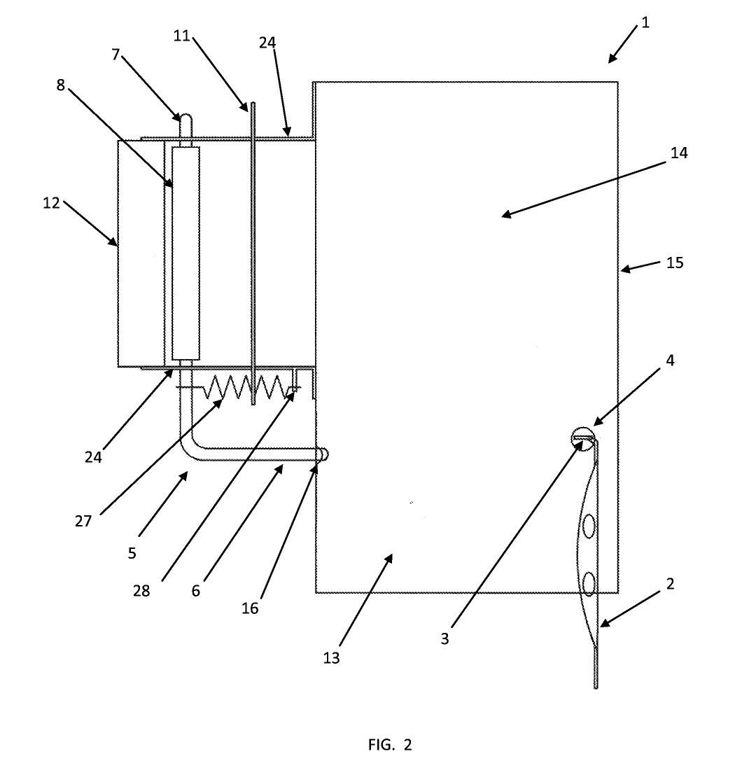

FIG. 2 is a side view of the invention with a section of the charcoal housing removed to better show the contoured single piece hinged grate in the open position with the release mechanism also shown in the open position.

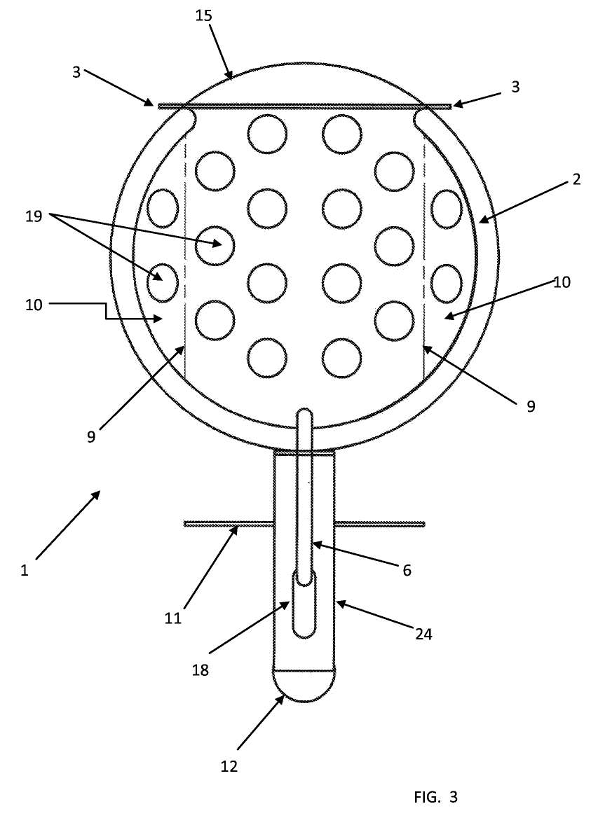

FIG. 3 is a bottom view of the invention with the contoured single piece hinged grate in the closed position with the release mechanism also in the closed position.

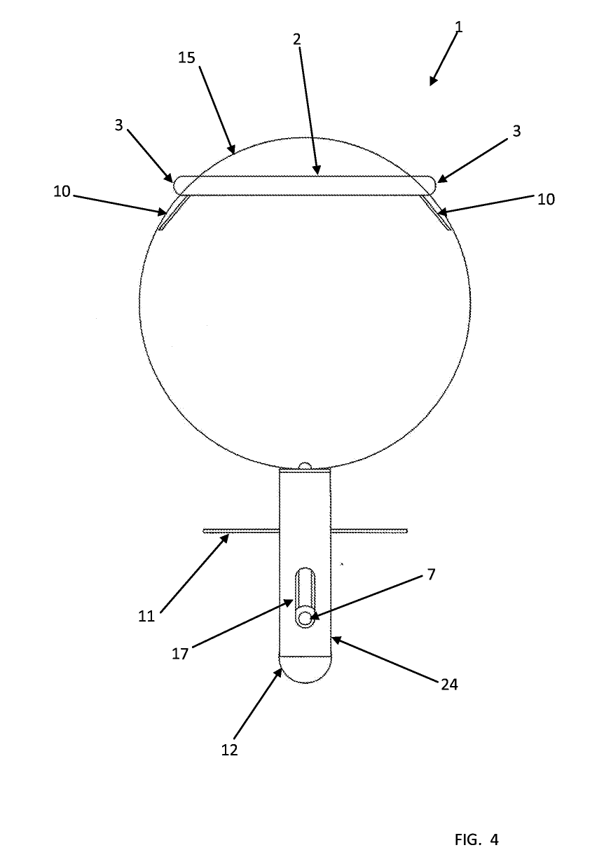

FIG. 4 is a top view of the invention with the contoured single piece hinged grate in the open position with the release mechanism also in the open position.

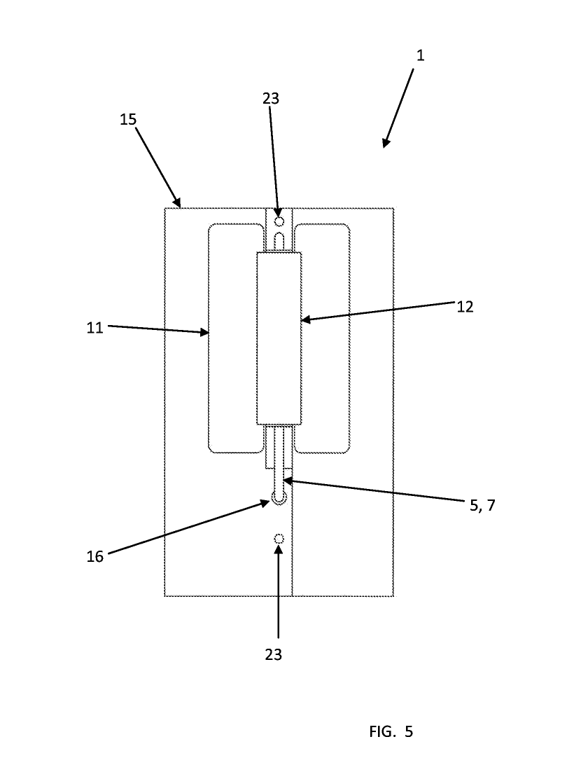

FIG. 5 is the side view of the invention shown in FIG. 1 with the charcoal starter housing rotated 90 degrees counterclockwise to show the main handle, heat shield, the release mechanism and the hole where the release mechanism protrudes through charcoal starter housing.

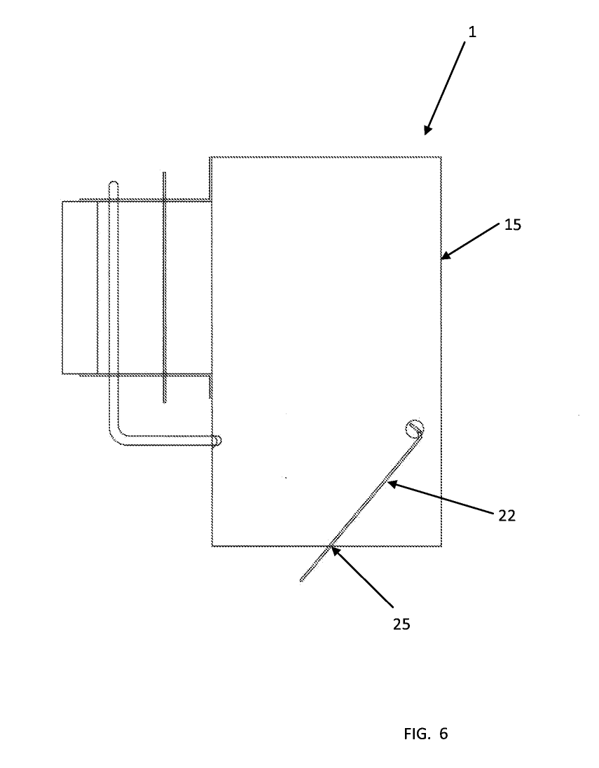

FIG. 6 is a side view of a charcoal starter with a section of the charcoal housing removed and a flat contoured single piece hinged grate showing an approximate impact point between the grate and the charcoal starter housing.

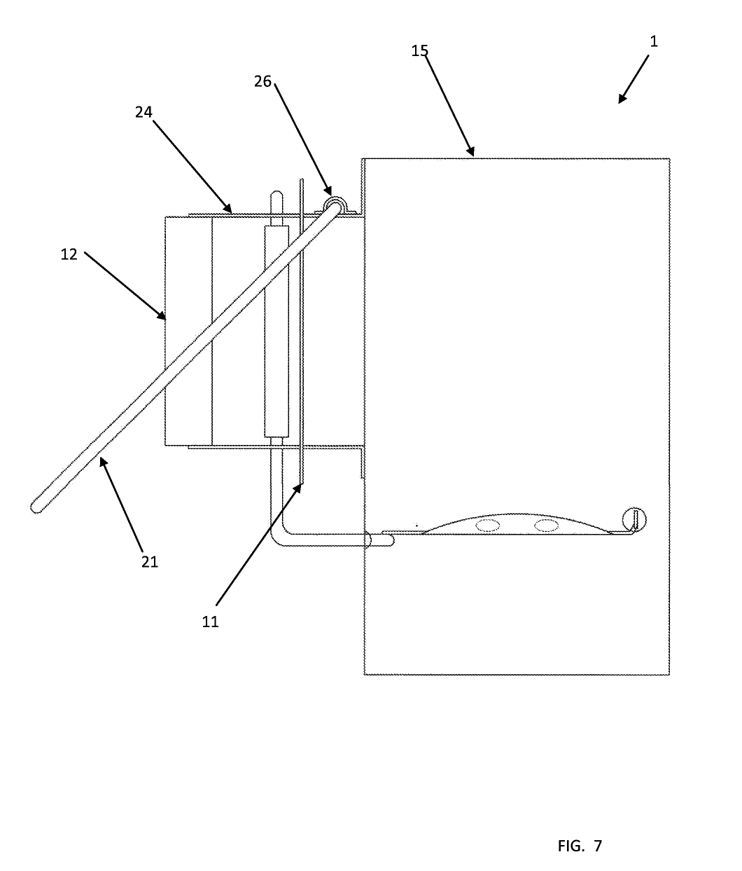

FIG. 7 is a side of the invention with a section of the charcoal housing removed and showing a location of the second handle.

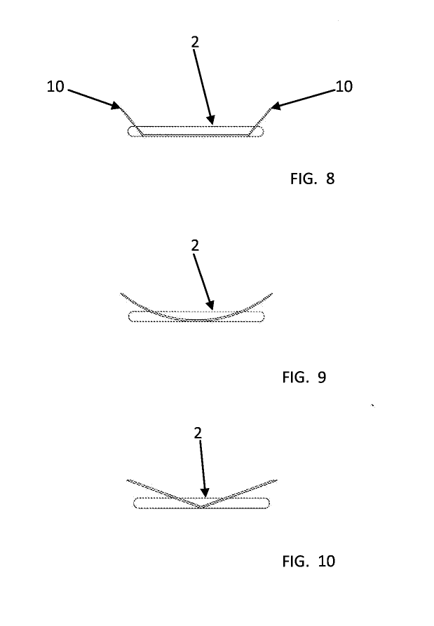

FIG. 8 is a profile view of the inventions preferred contoured single piece hinged grate, flat in the middle with each side bent up at an angle.

FIG. 9 is a profile view of an optional design for a contoured single piece hinged grate with a rounded contour.

FIG. 10 is a profile view of an optional design for a contoured single piece hinged grate with a “V” shaped contour.

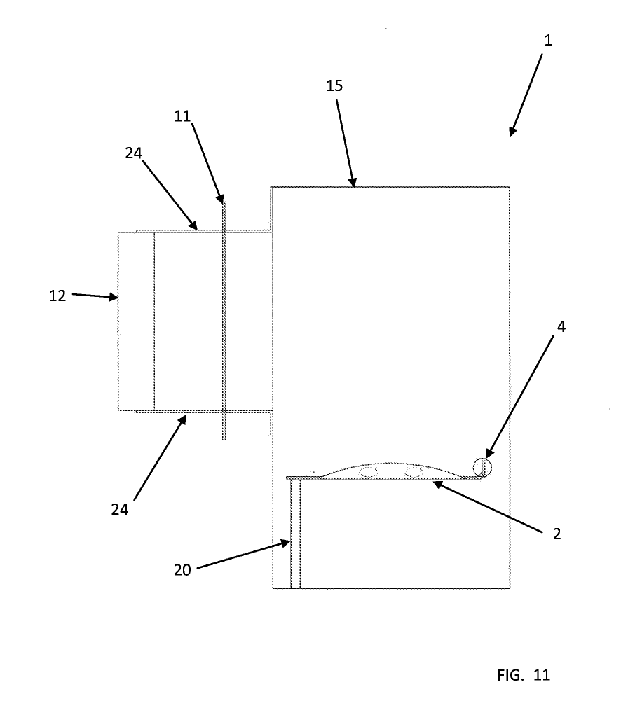

FIG. 11 is a side view of the invention with a section of the charcoal housing removed and a contoured single piece hinged grate that incorporates a standoff that is attached to the grate to hold shown in a horizontal or closed position.

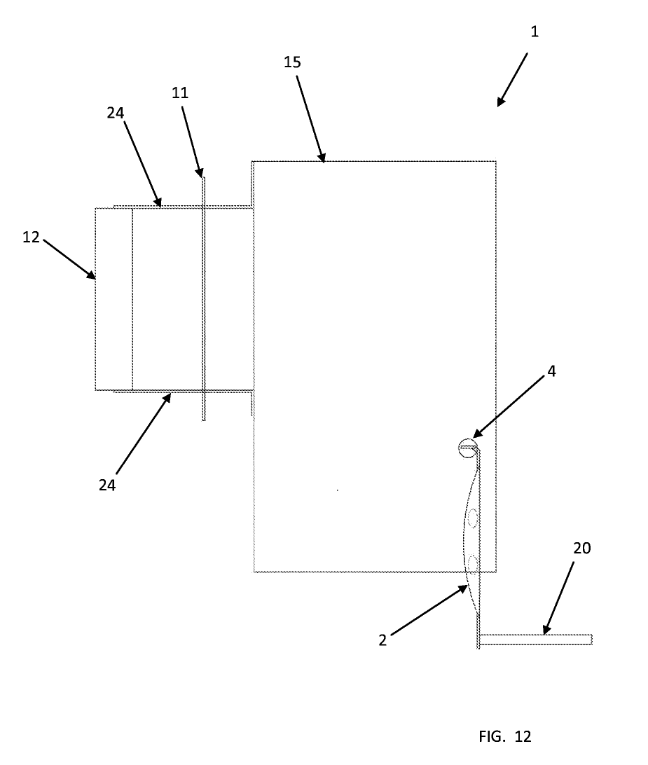

FIG. 12 is a side view of the invention with a section of the charcoal housing removed and a contoured single piece hinged grate that incorporates a standoff that is attached to the grate shown in a vertical or open position.

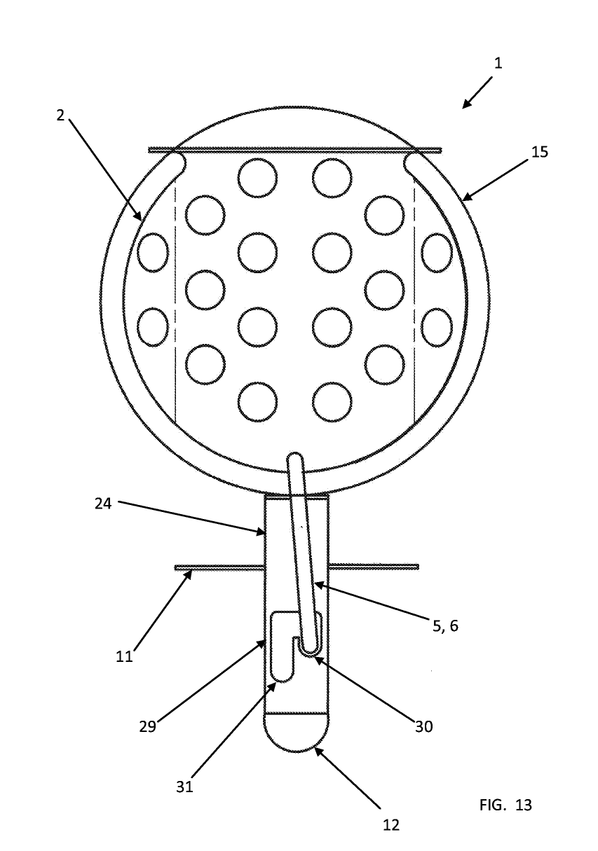

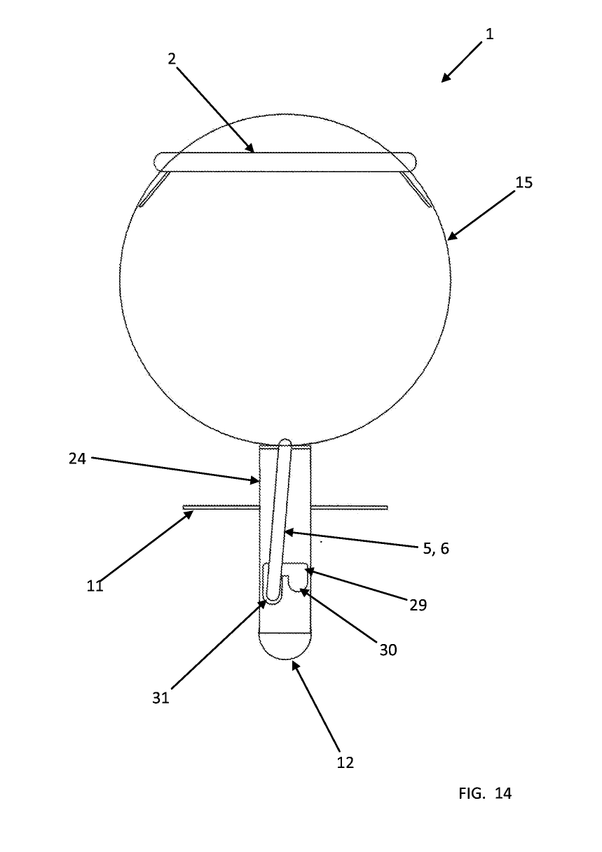

FIG. 13 is a bottom view of the cutout locking mechanism shown in the locked position.

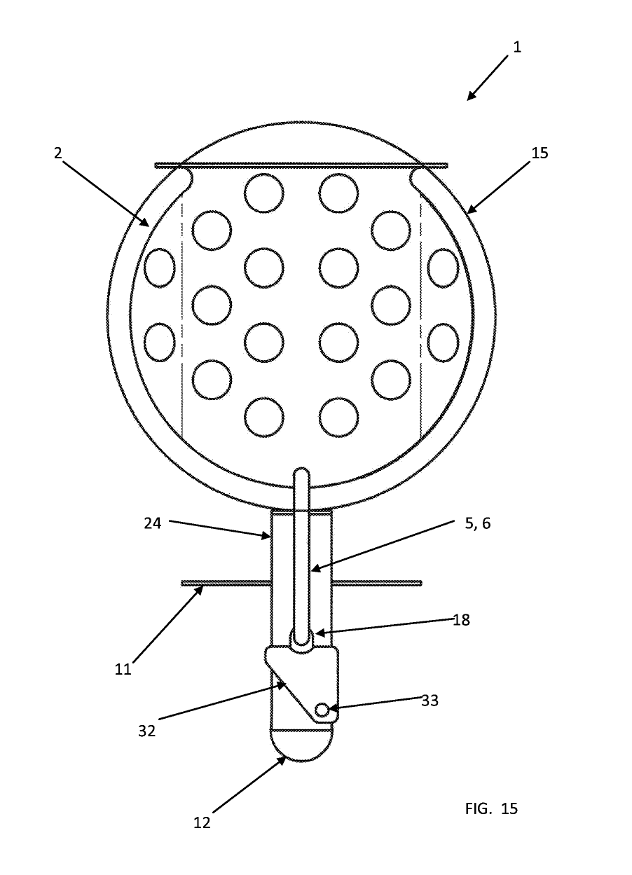

FIG. 14 is a bottom view of the cutout locking mechanism shown in the unlocked position.

FIG. 15 is a bottom view of an optional a movable tab locking mechanism shown in the locked position.

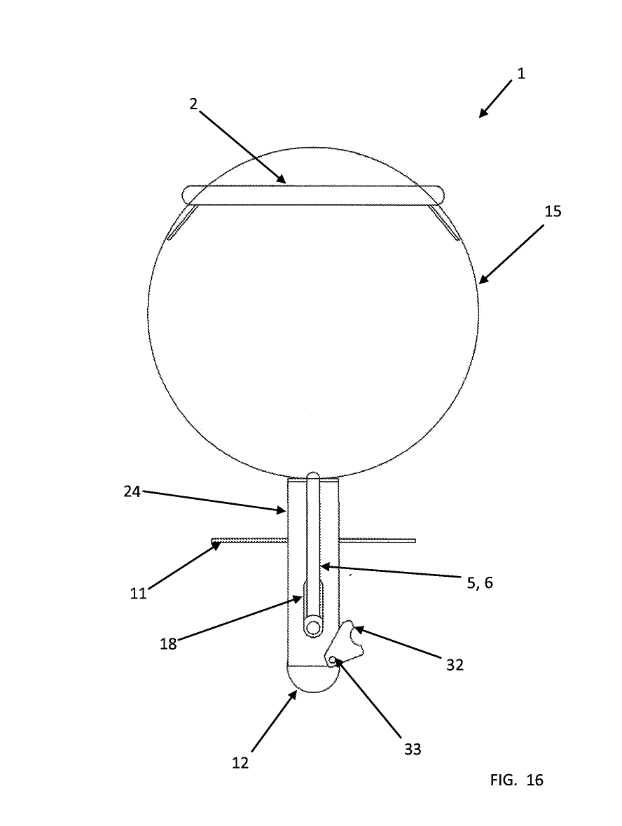

FIG. 16 is a bottom view of an optional a movable tab locking mechanism shown in the unlocked position.

### DETAILED DESCRIPTION OF THE PREFERRED EMBODIMENT

Referring to FIG. 1 which shows a side view of the preferred embodiment of the charcoal starter 1, a section of the charcoal starter housing 15 has been removed to show the contoured single piece hinged grate 2 and the release mechanism 5 in the closed position. The horizontal release member 6 is protruding through the charcoal starter housing 15 through the opening in the charcoal starter housing opening 16 and is positioned just below the contoured single piece hinged grate 2 holding it in the horizontal or closed position. The vertical release member 7 passes through the lower main handle support slot 17 (FIG. 4), the upper main handle support slot 18 (FIG. 3), which are located in main handle supports 24. The optional return spring 27 is attached at one end to the vertical release member 7 and the other end is attached to return spring support 28 which is attached to the main handle support 24. Return spring 27 is used to hold release mechanism 5 in the closed position, which holds the contoured single piece hinged grate 2 in the horizontal or closed position. Also shown is optional insulated handle 8 which is attached to vertical release member 7 to protect the user from heat that may be conducted away from the incandescent coals. Heat shield 11 is also shown positioned between charcoal starter housing 15 and main handle 12 to help reflect heat away from the user's hand. The contoured single piece hinged grate 2 divides the inside of charcoal starter 1 into lower chamber 13 and upper chamber 14, where the space created by upper chamber 14 is used to hold the charcoal and lower chamber 13 is used to hold the combustible that ignite the coals in upper chamber 14. The contoured single piece hinged grate 2 is held in the closed position at one end by the horizontal release member 6 and pivots at the other end about hinge tab 3 which is located in pivot hole 4.

FIG. 2 is a side view of charcoal starter 1, a section of the charcoal starter housing 15 has been removed to show to show the contoured single piece hinged grate 2 in the open position. Also shown in the open position is release mechanism 5. The contoured single piece hinged grate 2 is moved into the open position by pulling the vertical release member 7 back toward main handle 12. This will move horizontal release member 6 is the same direction and out from under the contoured single piece hinged grate 2 allowing it to rotate downward about the hinge tabs 3 in pivot hole 4.

FIG. 3 is a bottom view of charcoal starter 1 showing the contoured single piece hinged grate 2 in the closed position. Also seen in this view is lower main handle support slot 18 that the vertical release member 7 (FIG. 1), of release member 5, protrudes through.

With the contoured single piece hinged grate 2 in the closed position in this view the grate ventilation holes 19 are also seen. The heat and flames from combustible materials held in the lower chamber 13 (FIG. 1) pass through the holes and heat the charcoal located in the upper chamber 14 (FIG. 1). The contoured single piece hinged grate 2 is made to fit the contour of the charcoal starter housing 15 by bending both contour sections 10 upward at an angle at bend lines 9.

FIG. 4 is a top view charcoal starter 1 showing the contoured single piece hinged grate 2 in the open position. As seen in this view, horizontal release member 7 is in the back position of upper main handle support slot 17, which moved the horizontal release member 6 (FIG. 3) out from under the contoured single piece hinged grate 2 allowing it to rotate downward to the open position. The contoured single piece hinged grate 2 is contoured to fit the shape of the charcoal starter housing 15 by bending the contour sections 10 (FIG. 3) upward along bend line 9 (FIG. 3). The angle of the bends varies depending on the diameter of the charcoal starter housing 15.

FIG. 5 shows an end view of charcoal starter 1 that is has been rotated 90 degrees counterclockwise from the side view of FIG. 1. This view shows vertical release member 7 of release mechanism 5 passing through both main handle supports 24. It also shows charcoal starter opening 16 where horizontal release member 6 (FIG. 1) passes through the charcoal starter housing 15. Also shown in this view are main handle 12, heat shield 11 and assembly rivets 23 used to hold the housing together.

FIG. 6 is a side view of charcoal starter 1 with a section of charcoal starter housing 15 removed to expose a flat grate 22 instead of a contoured single piece grate 2 (FIG. 2). The problem with flat grate 22 is that as the diameter of flat grate 22 rotates downward it will hit the inside of charcoal starter housing 15 at impact point 25 which will prevent flat grate 22 from rotating to a completely open or vertical position. As seen from this view the charcoal could become jammed between charcoal housing 15 and flat grate 22. The charcoal will exit charcoal starter 1 back toward the user instead of straight down as it would with the contoured single piece hinged grate 2 (FIG. 2).

FIG. 7 is a side view of charcoal starter 1 with a section of the charcoal starter housing 15 removed to show the contoured single piece hinged grate 2. In order to aid in the lifting, positioning and controlling of charcoal starter 1 when it is filled with hot charcoal embers, second handle 21 has been added to the top main handle support 24. As shown here, the second handle support 26 has been added to attach second handle 21 to the top main handle support 24. Depending on the location of heat shield 11, the second handle 21 and the second handle support 26 could be attached to the upper main handle support 24 either between the charcoal starter housing 15 and the heat shield 11 or if the heat shield 11 is closer to the charcoal starter housing 15 and does not allow enough room to attach second handle 21, then second handle 21 and second handle support 26 could be attached to the upper main handle support 24 between heat shield 11 and main handle 12. The second handle 21 would be pivotally attached to the upper main handle support 24.

FIG. 8 is a profile view of the preferred contoured single piece hinged grate 2. The shape of the contour is flat across the middle with contour sections 10 bent upward along bend lines 9 (FIG. 3). The angle of the bends will vary depending on the diameter and shape of the charcoal housing 15.

FIG. 9 is a profile view of an optional contour for the contoured single piece hinged grate 2. The contour of this option is a radius that complements the shape of charcoal housing 15 such that it rotated to a substantially vertical or open position.
FIG. 10 is a profile view of another optional contour for the contoured single piece hinged grate 2. The contour of this option is a “V” shape that complements the shape of charcoal housing 15 such that it rotated to a substantially vertical or open position.

FIG. 11 is a side view of charcoal starter 1 with a section of the charcoal starter housing 15 removed to show the contoured single piece hinged grate 2. A cost reduced version of the charcoal starter 1 with the contoured single piece hinged grate 2 would remove the release mechanism 5 (FIG. 1) and add the grate support protrusion 20 to the single piece hinged grate 2. In the closed position, as shown here, the vertical length of the grate support protrusion 20 should be approximately equal to the distance from center of pivot hole 4 to the bottom of charcoal housing 15. This distance will allow the contoured single piece hinged grate 2 to rest in a horizontal or closed position.

FIG. 12 is a side view of charcoal starter 1 with a section of the charcoal starter housing 15 removed to show the contoured single piece hinged grate 2. In the closed position (FIG. 11), the horizontal position of the grate support protrusion 20 should be greater than the distance from pivot hole 4 to the bottom of the charcoal housing 15. As seen in this view, the contoured single piece hinged grate will then be able to rotate about pivot hole 4 to a vertical or open position without the grate support 20 hitting the charcoal housing 15.

FIG. 13 is a bottom view of charcoal starter 1 showing charcoal starter housing 15, contoured single pieced hinged grate 2 and heat shield 11. In order to prevent the accidental activation of release mechanism 5, cutout locking feature 29 has been added to the lower main handle support 24. When the horizontal release member 6 is in locked position 30, it cannot be pulled back toward handle 12, thus preventing the contoured single piece hinge 2 from rotating into the open position.

FIG. 14 is a bottom view of charcoal starter 1 showing charcoal starter housing 15, contoured single pieced hinged grate 2 and heat shield 11. To activate release mechanism 5, that is in the locked position of cutout locking feature 29 of the lower main handle support 24 (FIG. 13), the horizontal release member 6 is moved from locked position 30 to the unlocked position 31. When the horizontal release member 6 is pulled all the way back toward handle 12 and into the unlocked position 30, the contoured single piece hinge 2 will be able to rotate into the open position.

FIG. 15 is a bottom view of charcoal starter 1 showing charcoal starter housing 15, contoured single pieced hinged grate 2 and heat shield 11. In order to prevent the accidental activation of release mechanism 5, locking tab 32 has been added to the lower main handle support 24 and is held in place by locking tab hinge pin 33. When locking tab 32 is aligned with horizontal release member 6, the horizontal release member 6 is in the locked position and cannot be pulled back toward handle 12, thus preventing the contoured single piece hinge 2 from rotating into the open position.

FIG. 16 is a bottom view of charcoal starter 1 showing charcoal starter housing 15, contoured single pieced hinged grate 2 and heat shield 11. To activate of release mechanism 5, locking tab 32, attached to the lower main handle support 24, is rotated about locking tab hinge pin 33 to bring it out of align with release mechanism 6. When locking tab 32 is rotated out of align with horizontal release member 6, the horizontal release member 6 can be pulled back toward handle 12, allowing the contoured single piece hinge 2 to rotate into the open position.

What is claimed:

1. A charcoal starter with vertical side walls creating an enclosure with an opening at the top and at the bottom, a plurality of perforations in said enclosure for ventilation, a handle comprised of a substantially vertical member and at least one additional support member attached to said handle vertical member at an angle which is used to attached said handle to the outside of said enclosure for portability, a heat shield located between said handle vertical member and said enclosure, a contoured single piece perforated grate located on the inside of said enclosure, where said grate is pivotally attached to said enclosure such that when said grate is rotated into a substantially horizontal or closed position, said grate separates the inside of said enclosure into an upper chamber and a lower chamber, said grate also comprising of a contour that compliments the inside form of said enclosure such that when said grate rotates downward into a substantially vertical or open position, it creates an opening between said upper and lower chambers, a release mechanism that is located below said contoured single piece hinged grate, where said release mechanism can be moved into two positions, where in the first position the release mechanism protrudes below said grate, holding said grate in substantially horizontal or closed position creating said upper and lower chambers, when said release mechanism is moved into the second position, it no longer protrudes below said grate, therefore allowing said grate to rotate into a downward position creating said opening between said upper and lower chambers.

2. The release mechanism of claim 1 having both a substantially horizontal member and a substantially vertical member, where said horizontal member is positioned below said grate and said vertical member is located between said handle and said enclosure, and where said release mechanism can be moved into two positions, a first position and a second position, where, when said release mechanism can be placed in said first position by pushing forward on said vertical release member away from said handle, the horizontal member will then protrude below said grate holding it in said closed position creating said upper and lower chambers and when moved into second position by pulling backward on said vertical release member toward said handle, said horizontal release member no longer protrudes below said grate and allowing said grate to rotate into said open position.

3. The release mechanism of claim 2 where the vertical release member is thermally insulated.

4. The release mechanism of claim 1 and claim 2 having a spring mechanism biased toward holding said release mechanism in a position where it protrudes into said housing such that it prevents said grate from rotating downward from a closed position to an open position.

5. The charcoal starter of claim 1 having a locking mechanism that prevents said release mechanism from moving from first position to said second position.

6. A charcoal starter with vertical side walls making an enclosure with an opening at the top and at the bottom, a plurality of perforations in said enclosure for ventilation, a handle comprised of a substantially vertical member and at least one additional support member attached to said vertical member at an angle which is used to attach said handle to the outside of said enclosure for portability, a heat shield located between said handle vertical member and said enclosure, a contoured single piece perforated grate located on the inside of said enclosure, where said grate is pivotally attached to said enclosure such that when said grate is rotated into a horizontal or closed position, it separates the inside of said enclosure into an upper chamber and a lower chamber, said grate also comprising of a contour that compliments the inside form of said enclosure such that when said grate rotates downward, it rotates into a substantially vertical or open position creating an opening between said upper and lower chambers, a standoff that is fixedly attached to said grate, where said standoff protrudes perpendicular to said grate, and protrudes below said contoured single piece hinged grate, where said standoff has a length substantially equal to the distance between said grate hinge and the bottom of said enclosure such that when the bottom of said enclosure rests on a surface, said standoff holds said grate in a substantially horizontal or closed position creating said upper and lower chambers, and where said standoff is of a distance from said grate hinge greater than the distance from said grate hinge to the bottom of said enclosure such that when said enclosure is lifted from its rest position on a surface, said grate will rotate about said hinge in a downward direct into said open position and said standoff does not come in contact with said enclosure.

7. A charcoal starter with vertical side walls making an enclosure with an opening at the top and at the bottom, a first handle comprised of a substantially vertical member and at least one additional support member attached to said vertical member at an angle which is used to attach said first handle to the outside of said enclosure for portability, a heat shield located between said first handle vertical member and said enclosure, a single piece perforated grate located on the inside of said enclosure, where said grate separates the inside of said enclosure into an upper chamber and a lower chamber, a plurality of perforations in said enclosure for ventilation, a second handle pivotally attached to said first handle support member to aid stability during transport and handling of said enclosure.

8. The second handle of claim 5 where said second handle is thermally insulated.

9. A charcoal starter with vertical side walls creating an enclosure with an opening at the top and at the bottom, a plurality of perforations in said enclosure for ventilation, a handle comprised of a substantially vertical member and at least one additional support member attached to said handle vertical member at an angle which is used to attached said handle to the outside of said enclosure for portability, a heat shield located between said handle vertical member and said enclosure, a contoured single piece perforated grate located on the inside of said enclosure, where said grate is pivotally attached to said enclosure such that when said grate is rotated into a substantially horizontal or closed position, said grate separates the inside of said enclosure into an upper chamber and a lower chamber, said grate also comprising of a contour that compliments the inside form of said enclosure such that when said grate rotates downward into a substantially vertical or open position, it creates an opening between said upper and lower chambers, a release mechanism that is located below said contoured single piece hinged grate, where said release mechanism can be moved into two positions, where in the first position the release mechanism protrudes below said grate, holding said grate in substantially horizontal or closed position creating said upper and lower chambers, when said release mechanism is moved into the second position, it no longer protrudes below said grate, therefore allowing said grate to rotate into a downward position creating said opening between said upper and lower chambers, a second handle pivotally attached to said first handle support member to aid stability during transport and handling of said enclosure.

10. The release mechanism of claim 9 having both a substantially horizontal member and a substantially vertical member, where said horizontal member is positioned below said grate and said vertical member is located between said handle and said enclosure, and where said release mechanism can be moved into two positions, a first position and a second position, where, when said release mechanism can be placed in said first position by pushing forward on said vertical release member away from said handle, the horizontal member will then protrude below said grate holding it in said closed position creating said upper and lower chambers and when moved into second position by pulling backward on said vertical release member toward said handle, said horizontal release member no longer protrudes below said grate and allowing said grate to rotate into said open position.

11. The release member of claim 10 where the vertical release member is thermally insulated.

12. The second handle of claim 9 where said second handle is thermally insulated.

13. The release mechanism of claim 9 and claim 10 having a spring mechanism biased toward holding said release mechanism in a position where it protrudes into said housing such that it prevents said grate from rotating downward from a closed position to an open position.

14. The charcoal starter of claim 9 having a locking mechanism that prevents the release mechanism from moving from the closed position to the open position.

15. A charcoal starter with vertical side walls making an enclosure with an opening at the top and at the bottom, a handle comprised of a substantially vertical member and at least one additional support member attached to said vertical member at an angle which is used to attach said handle to the outside of said enclosure for portability, a heat shield located between said handle vertical member and said enclosure, a contoured single piece perforated grate located on the inside of said enclosure, where said grate is pivotally attached to said enclosure such that when said grate is rotated into a horizontal or closed position, it separates the inside of said enclosure into an upper chamber and a lower chamber, said grate also comprising of a contour that compliments the inside form of said enclosure such that when said grate rotates downward, it rotates into a substantially vertical or open position creating an opening between said upper and lower chambers, a standoff that is fixedly attached to said grate, where said standoff protrudes perpendicular to said grate, and protrudes below said contoured single piece hinged grate, where said standoff has a length substantially equal to the distance between said grate hinge and the bottom of said enclosure such that when the bottom of said enclosure rests on a surface, said standoff holds said grate in a substantially horizontal or closed position creating said upper and lower chambers, and where said standoff is of a distance from said grate hinge greater than distance from said grate hinge to the bottom of said enclosure such that when said enclosure is lifted from its rest position on a surface, said grate will rotate about said hinge in a downward direct into said open position and said standoff does not come in contact with said enclosure, a second handle pivotally attached to said first handle to aid stability during transport and handling of said enclosure.

16. The second handle of claim 11 where said second handle is thermally insulated.
